(19) United States
(12) Patent Application Publication
(10) Pub. No.: US 2006/0266238 A1
(43) Pub. Date: Nov. 30, 2006

(54) Device for throwing-on impression and throwing-off impression in a printing press and printing press having the device

(76) Inventor: Steffen Derhardt, Heidelberg (DE)

Correspondence Address: LERNER GREENBERG STEMER LLP, P O BOX 2480, HOLLYWOOD, FL, 33022-2480, US

(21) Appl. No.: 10/624,954

(22) Filed: Jul. 22, 2003

(30) Foreign Application Priority Data
Jul. 22, 2002 (DE) 102 33 147.2

(51) Int. Cl. B41F 7/02

(52) U.S. Cl. 101/218

(57) ABSTRACT

A device for throwing-on and throwing-off printing in a printing press, includes an impression cylinder, a form and/or blanket cylinder, a cylinder throw-on and throw-off bearing for throwing the form and/or blanket cylinder on and off the impression cylinder, an applicator roller, and a roller throw-on and throw-off bearing for throwing the applicator roller on and off the form and/or blanket cylinder. The roller throw-on and throw-off bearing includes a rotatably mounted first actuating element. The cylinder throw-on and throw-off bearing includes a rotatably mounted second actuating element. A coupler forms a coupler mechanism together with the first and second actuating elements. A joint is provided through which one of the actuating elements is articulatingly connected in the manner of a thrust joint to the coupler. The joint has a dead thrust travel. A printing press having the device is also provided.

### BACKGROUND OF THE INVENTION

### Field of the Invention

The invention relates to a device for starting or throwing-on and discontinuing or throwing-off printing in a printing press having an impression cylinder, a form and/or a blanket cylinder, a cylinder throw-on and throw-off bearing for throwing the form and/or the blanket cylinder on and off the impression cylinder, an applicator roller and a roller throw-on and throw-off bearing for throwing the applicator roller on and off the form and/or the blanket cylinder. The invention also relates to a printing press having the device.

The invention has originated against a background wherein specific printing jobs are performed requiring printing of the sheets in offset printing units, yet not requiring subsequent varnishing of the sheets in the varnishing unit of the offset printing press. During the processing of such a printing job, the varnishing unit is operated in a so-called inactive mode, wherein the sheets already provided with the offset prints are conveyed through the varnishing unit without being varnished therein. During the inactive mode, the form and/or the blanket cylinder are kept at a distance from the impression cylinder sufficiently great enough for avoiding contact between the impression cylinder and the trailing edge of the sheets transported past the form and/or the blanket cylinder, which would otherwise result in set-off or smearing. For setting or adjusting the aforementioned distance between the cylinders, special design precautions relating to mounting the form and/or the blanket cylinder are necessary.

In accordance with the prior art represented by German Published, Non-prosecuted Patent Application DE 199 37 469 A1, the precautions may be, for example, in mounting the form and/or the blanket cylinder in a swiveling mechanism, by which the distance between the two cylinders is settable. From the drawing of this published German patent application, it is readily apparent that an applicator roller is mounted eccentrically in a swivel joint.

In German Published, Non-Prosecuted Patent Application 2153 690, a device for starting or throwing-on and discontinuing or throwing-off printing is described, which originates against a background quite different from that of the invention of the instant application, and which represents only a further state of the art. In this device, the eccentric bushing of a form cylinder, to which a plurality of applicator rollers are assigned, is coupled through a coupler to the eccentric bushing of a blanket cylinder.

### SUMMARY OF THE INVENTION

It is accordingly an object of the invention to provide a device for starting or throwing-on and discontinuing or throwing-off printing and a printing press having the device, which overcome the hereinafore-mentioned disadvantages of the heretofore-known devices of this general type and which are suitable for use in a varnishing or printing unit which must often have to be operated in a so-called inactive mode.

With the foregoing and other objects in view there is provided, in accordance with the invention, a device for starting or throwing-on and discontinuing or throwing-off printing in a printing press. The device includes an impression cylinder, a form and/or blanket cylinder, a cylinder throw-on and throw-off bearing for throwing the form and/or blanket cylinder on and off the impression cylinder, an applicator roller, and a roller throw-on and throw-off bearing for throwing the applicator roller on and off the form and/or blanket cylinder. The roller throw-on and throw-off bearing includes a rotatably mounted first actuating element. The cylinder throw-on and throw-off bearing includes a rotatably mounted second actuating element. A coupler, together with the first and second actuating elements, forms a coupler mechanism. A joint is provided through which one of the actuating elements is connected for articulation in the manner of a thrust joint to the coupler. The joint has a dead thrust travel.

In accordance with another feature of the invention, the first actuating element is an eccentric bushing.

In accordance with a further feature of the invention, the second actuating element is a cam ring.

In accordance with an added feature of the invention, the first actuating element is connected to the coupler in the manner of a thrust joint through the joint.

In accordance with an additional feature of the invention, the joint is a rotary and thrust joint.

In accordance with yet another feature of the invention, the rotary and thrust joint is formed with a slot and a joint pin both rotatably and displaceably guidable in the slot.

In accordance with yet a further feature of the invention, the applicator roller is assigned as a single applicator roller to the form and/or blanket cylinder.

With the objects of the invention in view, there is also provided a printing press, comprising a device for starting or throwing-on and discontinuing or throwing-off printing in a printing press. The device includes an impression cylinder, a form and/or blanket cylinder, a cylinder throw-on and throw-off bearing for throwing the form and/or blanket cylinder on and off the impression cylinder, an applicator roller, and a roller throw-on and throw-off bearing for throwing the applicator roller on and off the form and/or blanket cylinder. The roller throw-on and throw-off bearing includes a rotatably mounted first actuating element. The cylinder throw-on and throw-off bearing includes a rotatably mounted second actuating element. A coupler, together with the first and second actuating elements, forms a coupler mechanism. A joint is provided through which one of the actuating elements is connected for articulation in the manner of a thrust joint to the coupler. The joint has a dead thrust travel.

In the device according to the invention, the construction preconditions for the displacement of the form and/or blanket cylinder to a distance from the impression cylinder which is sufficiently great enough for the inactive mode are provided. The number of joints affected by play which are present between a machine side wall and the form and/or blanket cylinder is low, so that the device has great stability and rigidity and is therefore also suitable for use in a large-format press.

Another designation for the “dead thrust travel” is “lost motion”. The dead thrust travel is dimensioned in terms of the length thereof so that, over the dead thrust travel, a movement of the coupler is made possible without driving, by the coupler, that actuating element to which the coupler is connected in the manner of a thrust joint by the joint.

If one joint half of the joint is displaced along the other joint half within the dead thrust travel, the coupler then executes an idle stroke. The dead thrust travel is, so to speak, thrust play which is limited in such a way that the movement of the coupler within the dead thrust travel is not transmitted to the actuating element connected to the coupler and is transmitted to the aforementioned actuating element only after the end of the dead thrust travel has been reached. The explanations given hereinbefore in relation to the dead thrust travel were based on the exemplary assumption that the coupler is the driving part and the actuating element connected to the coupler through the joint is the driven part, i.e., the output rocker of the coupler mechanism. This assumption applies if the first actuating element of the roller throw-on and throw-off bearing is connected to the coupler in the manner of a thrust joint through the aforementioned joint, as is also provided in accordance with a preferred development of the invention.

Instead of this, however, it is also possible for the second actuating element of the cylinder throw-on and throw-off bearing to be connected to the coupler in the manner of a thrust joint by the joint. In the last-mentioned case, the actuating element connected to the coupler in the manner of a thrust joint by the joint is the drive rocker of the coupler mechanism or the driving part, and the coupler is the driven part, and the dead thrust travel is dimensioned in terms of the length thereof so that, over the dead thrust travel, a movement of the actuating element to which the coupler is connected in the manner of a thrust joint by the joint is made possible without entrainment of the coupler by the last-mentioned actuating element.

Hereinafter, some developments of the device according to the invention are explained in detail.

Both the first and the second actuating element can be an eccentric bushing or a cam ring. It is preferable for the first actuating element to be an eccentric bushing and for the second actuating element to be a cam ring. The construction of the second actuating element as the cam ring is advantageous with regard to a particularly large actuating travel of the cylinder throw-on and throw-off bearing and therefore an adjustable clearance between the cylinders.

With regard to cost-effective fabrication, the construction of the joint as a rotary and thrust joint, which includes a slot and a joint pin guided in the slot so that it can be both rotated and displaced, is advantageous.

Differing from this, however, it is also possible to connect the coupler to the appropriate actuating element in an articulated manner by two joints, specifically a rotary joint and a thrust joint, instead of by the single rotary and thrust joint, for example by the joint pin being guided with the one pin end thereof in a so that it can be displaced but not rotated, and being guided with the other pin end thereof in a hole so that it can only rotate. In the last-mentioned case, the slot and the pin end guided displaceably therein form the aforementioned thrust joint, and the hole and the pin end guided in the latter form the aforementioned rotary joint. If the rotary joint is disposed on the coupler, the thrust joint is then disposed on the actuating element connected articulatingly to the coupler. A configuration interchanged with respect thereto, wherein the thrust joint is disposed on the coupler and the rotary joint on the actuating element connected articulatingly to the coupler, is likewise possible. With regard to an inexpensive and nevertheless absolutely functionally reliable construction of the device, it is advantageous for the applicator roller to be assigned to the form and/or blanket cylinder as a single applicator roller. As a result of only the single applicator roller being used, a mechanism provided for actuating the roller throw-on and throw-off bearing can have a comparatively simple construction. The single applicator roller inks the form and/or blanket cylinder just as thoroughly and precisely as would be done by two or more applicator rollers, but this would need a corresponding number of roller throw-on and throw-off bearings and a comparatively complicated mechanism in order to actuate these roller throw-on and throw-off bearings.

The device according to the invention is particularly suitable for use in a varnishing, flexographic printing or coating mechanism of a printing press, wherein there is the requirement for displacing the plate and/or blanket cylinder not just into the “printing on” position and the “printing off” position but, furthermore, also into a third position for the inactive participation of the unit in the printing process.

Other features which are considered as characteristic for the invention are set forth in the appended claims.

Although the invention is illustrated and described herein as embodied in a device for starting or throwing-on and discontinuing or throwing-off printing in a printing press and a printing press having the device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a varnishing unit with two throw-on and throw-off bearings connected by a coupler to one another;

FIG. 2 is an enlarged, fragmentary view of FIG. 1, showing various mechanisms and drives of the varnishing unit, which serve for displacing the throw-on and throw-off bearings, and which were omitted from FIG. 1; and

FIG. 3 is another enlarged, fragmentary view of FIG. 1, showing a securing device of the varnishing unit, which was omitted from FIGS. 1 and 2.

### DESCRIPTION OF THE PREFERRED EMBODIMENTS

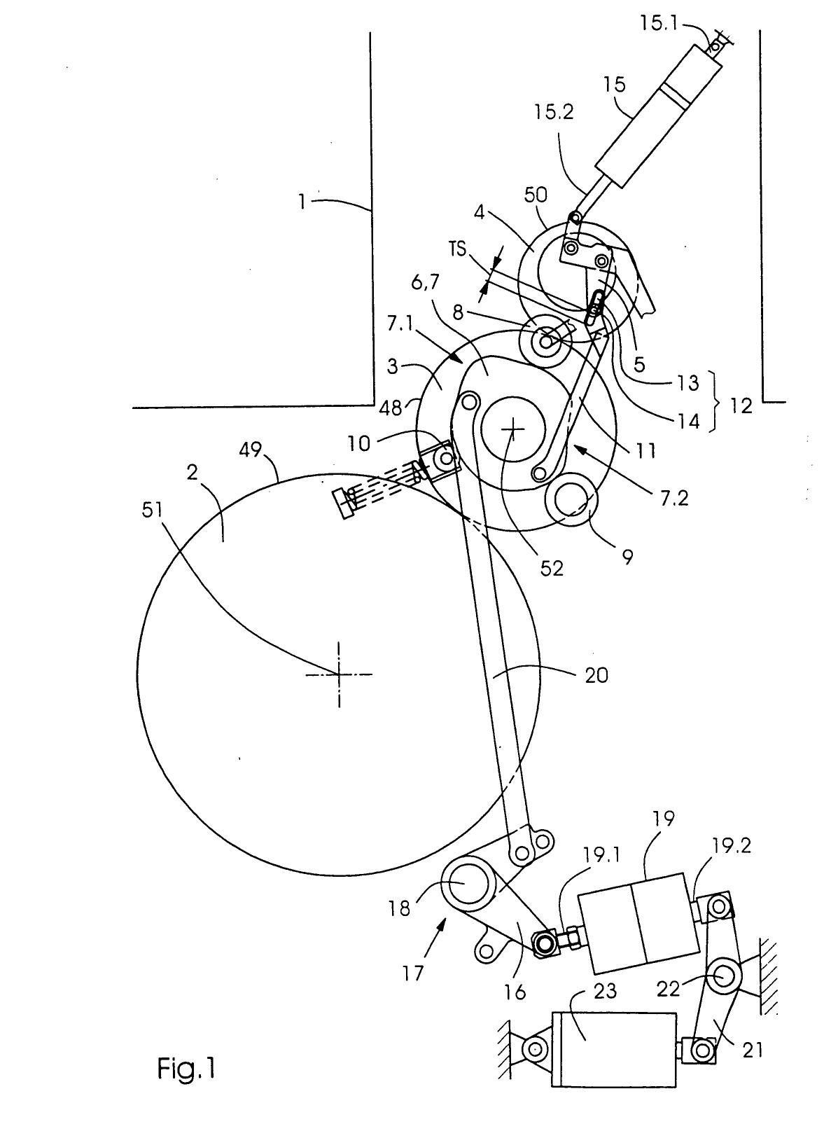

Referring now in detail to the figures of the drawings as a whole, it is seen that FIGS. 1 to 3 illustrate details of a rotary printing press 1 for printing a sheet of printing material. The details of the rotary printing press 1 include a printing unit serving for varnishing or coating the printing material, in addition to offset printing units disposed upstream of this first-mentioned printing unit, which is hereinafter referred to as a varnishing printing unit, as viewed in the printing material transport direction.

The varnishing printing unit is made up of an impression cylinder 2 having otherwise non-illustrated gripper systems, for holding the printing material, and a cylinder rolling on the printing material. The cylinder is namely a form and/or a blanket cylinder 3, onto which a flexographic printing form is clamped for spot varnishing, or a rubber blanket for total surface varnishing, or both cylinder covers (flexographic printing form and rubber blanket) are clampable mutually alternatingly. Furthermore, the afore-mentioned varnishing printing unit has only a single applicator roller 4 which, during the printing operation, rolls on the form and/or the blanket cylinder 3 and on the cylinder cover respectively clamped thereon. Advantageously, no further applicator roller is required for inking the cylinder cover, so that a technical configuration is provided which is relatively simple in construction and, therefore, cost-effective. If the applicator roller 4 is supplied with the varnish to be printed or, instead, a special ink or another coating liquid by a dip roller belonging to the varnishing printing unit, the applicator roller 4 is then a metering roller with a non-engraved or non-screened, smooth-surfaced circumferential surface. Otherwise, the applicator roller 4 can be an anilox and screen roller, respectively, against which there bears a metering doctor blade, for example, a chambered doctor blade.

In both of the aforementioned cases, the applicator roller 4 is mounted in a roller throw-on and throw-off bearing 5, which is constructed as an eccentric bushing or has such an eccentric bushing as a first actuating element, and serves for throwing the applicator roller 4 on and off the form and/or blanket cylinder 3. The latter is mounted in a cylinder throw-on and throw-off bearing 6, which is constructed as a so-called three-point mounting or bearing. The cylinder throw-on and throw-off bearing 6 includes, as a second actuating element, a rotatably mounted cam ring 7 having a circumferential or outer cam contour supported on three supporting rollers 8 to 10, one of which, namely the supporting roller 10, is spring loaded and therefore keeps the cam ring 7 pressed against the other two supporting rollers 8 and 9. The spring loaded supporting roller 10 is closest to the impression cylinder 2, of all the supporting rollers 8 to 10. The supporting roller 8 is located at least approximately on a center line connecting the center of the applicator roller 4 to the common center of the form and/or blanket cylinder 3 and the cam ring 7. The form and/or blanket cylinder 3 is rotatably mounted in the cam ring 7 by providing a cylinder axle journal of the form and/or blanket cylinder 3 plugged firmly into the inner ring of an antifriction or roller bearing. The cylinder throw-on and throw-off bearing 6 respectively serves for throwing the form and/or blanket cylinder 3 on and off the impression cylinder 2 and the printing material carried on the latter.

The cylinder throw-on and throw-off bearing 6 is mechanically connected to the roller throw-on and throw-off bearing 5 through a first coupler 11. The first coupler 11 is attached articulatingly by one end thereof to the cam ring 7 and by the other end thereof, through a first rotary and thrust joint 12, to the roller throw-on and throw-off bearing 5. The cam ring 7, therefore, forms a drive rocker, and the roller throw-on and throw-off bearing 5 respectively forms a driven rocker of a first coupler mechanism and four-bar mechanism to which the first coupler 11 also belongs.

The first rotary and thrust joint 12 includes a slot 13 formed in the first coupler 11 and a first joint pin 14 which is both rotatably and displaceably guided in the slot 13, the first joint pin 14 being formed as a sliding pin and being firmly seated in an arm mounted on or fitted to the roller throw-on and throw-off bearing 5.

A first pneumatically operating cylinder 15, which functions as a roller actuating drive for the applicator roller 4, is secured or attached to another arm, which is likewise fitted to or mounted on the roller throw-on and throw-off bearing 5. The first operating cylinder 15 is constructed as a so-called tandem cylinder which, in principle, is made up of two serially connected operating cylinders form one structural unit, the two reciprocating pistons of the operating cylinders being extendable after one another in mutually opposite directions. The two reciprocating pistons, respectively, form boundaries of two contraction and expansion chambers, which are fillable independently of one another with the pressurized fluid (compressed air) and belong to the first operating cylinder 15. Each of the two reciprocating pistons, respectively, forms a boundary of a different one of the two contraction and expansion chambers.

A first double-armed lever 16 is mounted so as to be pivotable or swivelable about a first locally fixed or stationary rotary joint 17, and is firmly fixed to a synchronizing shaft 18 against rotation relative thereto, whereon the first lever 16 is seated. A second pneumatically operating cylinder 19 is articulatingly attached to one of the lever arms of the first lever 16, and a second coupler 20 is articulatingly attached to the other lever arm of the first lever 16. The second operating cylinder 19 is likewise constructed as a tandem cylinder with two switching stages and functions as a cylinder actuating drive for the form and/or blanket cylinder 3. The second coupler 20 is attached to the cam ring 7 which, together with the second coupler 20 and the first lever 16, forms a second coupler mechanism or four-bar mechanism. More precisely expressed, the first lever 16 forms the drive rocker, and the cam ring 7 the driven rocker of the second four-bar mechanism.

A second double-armed lever 21 is mounted so as to be pivotable or swivelable about a second locally fixed or stationary second rotary joint 22 and is articulatingly attached by one of the lever arms thereof to the second operating cylinder 19, and by the other lever arm thereof to a third pneumatically operating cylinder 23. The first lever 16 is consequently articulatingly attached to a first piston rod 19.1 of the second operating cylinder 19, and the second lever 21 is articulately attached to a second piston rod 19.2 of the second operating cylinder 19. The third operating cylinder 23 is coupled by a single piston rod thereof to the second lever 21 and, at an end thereof located opposite from this piston rod, to a machine frame belonging to the rotary printing press 1. Swivel joints required for the articulated connections of the second lever 21 to the operating cylinders 19 and 23 and of the first lever 16 to the second operating cylinder 19 and the second coupler 20 are illustrated in FIG. 1 but not identified by reference numerals.

A non-illustrated modification is conceivable, according to which the third operating cylinder 23 is replaced by a different actuating drive, for example by an electric motor having a worm gear.

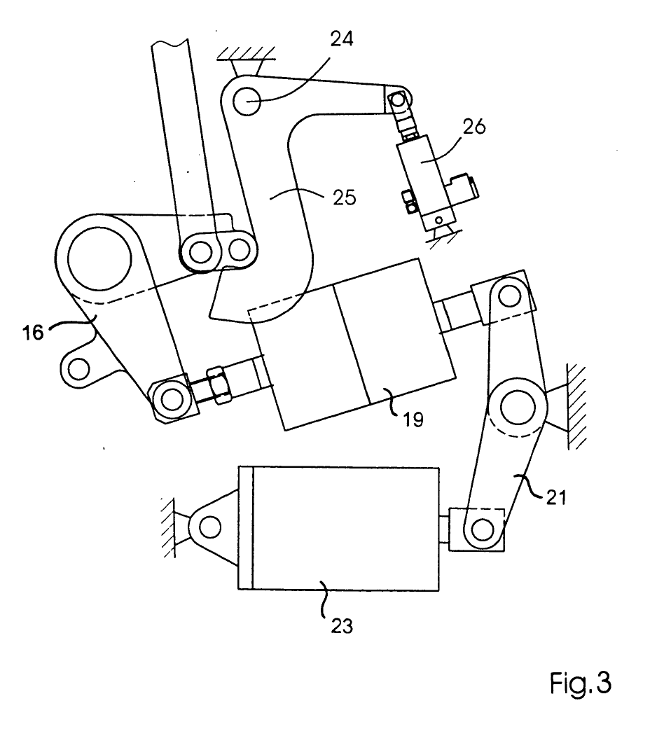

In an exemplary embodiment illustrated in FIG. 3, a double-armed pawl 25 is mounted so as to be swivelable about a stationary, third rotary joint 24, and serves as a locking and securing device for securing the first lever 16 and, through the second coupler 20, the cylinder throw-on and throw-off bearing 6, more precisely the cam ring 7, against unintentional displacement. A fourth pneumatically operating cylinder 26, is provided as a pawl actuating drive for displacing the pawl 25, as shown in FIG. 3, into a locking position thereof, wherein a catching hook belonging to the pawl 25 engages behind the first lever 16, and out of the locking position. The fourth operating cylinder 26 is attached by one end thereof to the machine frame and by the other end thereof to a first pawl arm of the pawl 25. As shown, the aforementioned catching hook is provided on a second pawl arm of the pawl 25.

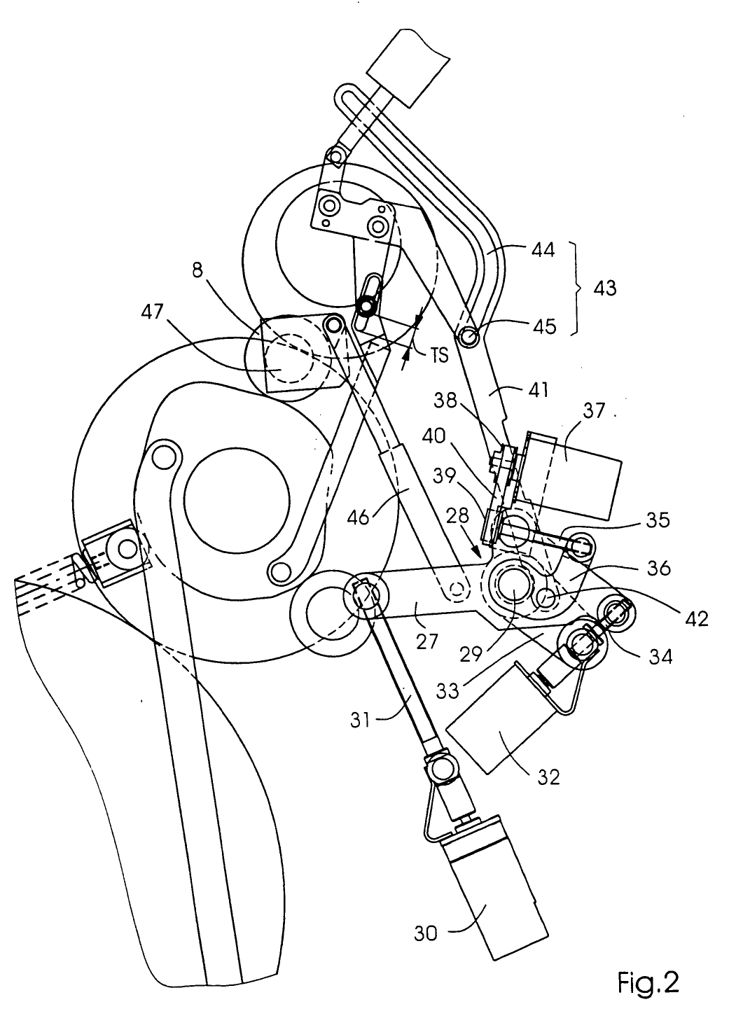

As shown in FIG. 2, a third lever 27 having three arms is mounted so as to be swivelable about a locally fixed or stationary, fourth swivel joint 28. The fourth swivel joint 28 is formed by a shaft 29, whereon the third lever 27 is seated so as to be rotatable relative to the shaft 29. The third lever 27 is swivelable through a first worm gear about the fourth swivel joint 28 by a first electric motor 30, which is fixed to the machine frame. The first worm gear includes a first threaded spindle 31, which is coupled to the motor shaft of the first motor 30 and could otherwise also be formed directly by the motor shaft of the first motor 31, and an internal thread (bolt nut) which is provided on a first lever arm of the third lever 27 and into which the first threaded spindle 31 is screwed.

A second electric motor 32 is fixed to a one-arm fourth lever 33, which is mounted so as to be rotatable coaxially with the third lever 27. The fourth lever 33 is seated on the shaft 29 and is firmly connected to the latter so as to be fixed against rotation relative thereto, and so that the fourth lever 33 and the shaft 29 are rotatable together relative to the third lever 27 only by the second motor 32 through a second worm gear. This second worm gear includes a second threaded spindle 34, which is coupled to the motor shaft of the second motor 32 and, instead, could also be formed directly by this motor shaft. The second threaded spindle 34 is screwed into an internal thread which is introduced into a bolt nut on the second lever arm of the third lever 27.

In a third lever arm of the third lever 27, a third threaded spindle 35 is mounted so as to be rotatable yet not displaceable, i.e., secured against thrust, the third threaded spindle 35 being screwed into an internal thread (bolt nut) which is located on a one-armed, fifth lever 36, so that the third lever 27 and the fifth lever 36 are connected to one another mechanically through a third worm gear mechanism including the third threaded spindle 35. The fifth lever 36 is mounted coaxially with the third lever 27 and with the fourth lever 33, the fifth lever 36 being seated on the shaft 29 so as to be rotatable relative to the latter. Via the third threaded spindle 35, the fifth lever 36, provided that the third threaded spindle 35 does not itself rotate, is firmly connected so as to be fixed against relative rotation with and in an angularly rigid manner, respectively, to the third lever 27. Because of this angularly rigid connection of the two levers 27 and 36 to one another, when the third threaded spindle 35 is stationary, the two levers 27 and 36 are pivotable together about the shaft 29 only by the first motor 30.

A third electric motor 37 fixed to the third lever arm of the third lever 27 has a motor shaft which is aligned in parallel with the third threaded spindle 35 and serves for rotating the third threaded spindle 35 through a formlocking flexible drive mechanism. In this regard, it is noted that a formlocking connection is one which connects two elements together due to the shape of the elements themselves, as opposed to a force-locking connection, which locks the elements together by force external to the elements. The aforementioned flexible drive mechanism includes a first gear wheel 38 which is coaxial with the motor shaft of the third motor 37 and firmly connected to this motor shaft so as to be fixed against rotation relative thereto, a second gear wheel 39 which is coaxial with the third threaded spindle 35 and firmly connected to the latter so as to be fixed against rotation relative thereto, and an endless toothed belt 40 which wraps around the two gear wheels 38 and 39 and has a formlocking connection with the gear wheels 38 and 39, i.e., with meshing teeth, expressed in practical terms, the toothed belt 40 being prestressed due to the inherent elasticity thereof. The first gear wheel 38 is firmly seated on the motor shaft of the third motor 37 so as to rotate therewith, and could also instead be formed by direct toothing of this motor shaft. The second gear wheel 39 is firmly seated on the third threaded spindle 35 so as to be fixed against rotation relative thereto, and could also be formed instead by direct toothing of the third threaded spindle 35. The inherent rotation of the third threaded spindle 35, driven by the third motor 37, causes the fifth lever 36, as desired, depending upon the respectively switched direction of rotation of the third motor 37, either to be swiveled towards and screwed away from, respectively, the third lever arm of the third lever 27.

The fifth lever 36 is connected mechanically through a third coupler 41 to the eccentric bushing (the roller throw-on and throw-off bearing 5). The third coupler 41 is attached to the fifth lever 36 through a fifth rotary joint 42 and, through a second rotary and thrust joint 43, to the eccentric bushing 5 and, more precisely, to a further arm fitted to or mounted on the eccentric bushing 5. The fifth lever 36 forms the drive rocker, and the eccentric bushing 5 forms the driven rocker of a third coupler or four-bar mechanism, respectively, to which the third coupler 41 also belongs. The second rotary and thrust joint 43 is made up of a guide slot 44 introduced into the third coupler 41 and a second joint pin (sliding pin) 45 which is rotatable in the guide slot 44 and displaceable along the guide slot 44, and is firmly seated in the last-mentioned further arm of the eccentric bushing 5. The guide slot 44 has two linear slotted guide regions and a curved slotted guide region located between the two linear slotted guide regions.

A fourth coupler or four-bar mechanism includes a fourth coupler 46, which is attached articulatingly by a coupler end thereof to the first lever arm of the third lever 27 and by the other coupler end thereof to an arm of a bearing and eccentric pin 47, whereon the supporting roller 8 is rotatably seated and which is mounted such that it can rotate about a pin axis offset eccentrically relative to the axis of rotation of the supporting roller 8. The third lever 27 thus forms the drive rocker, and the eccentric pin 47 forms the driven rocker of the fourth four-bar mechanism.

Disposed coaxially with the form and/or blanket cylinder 3 and firmly connected to the latter for rotating therewith is a third gear wheel 48 formed with end-face toothing. The pitch circle diameter of the third gear wheel 48 is of at least approximately the same size as the external diameter of the form and/or blanket cylinder 3. A fourth gear wheel 49, which is likewise formed with end-face toothing and which has a pitch circle diameter of at least approximately the same size as the external diameter of the impression cylinder 2, is disposed coaxially with the impression cylinder 2 and firmly connected to the latter for rotating together therewith. A fifth gear wheel 50 formed with end-face toothing has a pitch circle diameter which is of at least approximately the same size as the external diameter of the applicator roller 4. The fifth gear wheel 50 is disposed coaxially with the applicator roller 4 and firmly connected to the latter for rotating together therewith. The aforementioned three gear wheels 48 to 50 of the cylinders 2 and 3 and the applicator roller 4 are represented diagrammatically in the drawings only by the pitch circles thereof.

Hereinafter, different operating modes of the rotary printing press 1 and functions of the heretofore explained mechanisms related with these operating modes are described in detail.

The rotary printing press 1 is operatable selectively in a first printing operating mode and a second printing operating mode.

In the first printing operation mode, the printing material is initially printed with a multicolor imprint in the offset printing units and then printed, for example with a clear varnish protective layer covering the multicolor imprint, in the varnishing printing unit. When the first printing operating mode is carried out with the active participation of the varnishing printing unit, a print throw-off may be required before a stoppage and a print throw-on after the stoppage.

The print throw-off is performed automatically in the two steps described hereinbelow.

In a first print throw-off step, the applicator roller 4 is thrown off the form and/or blanket cylinder 3. For this purpose, the first contraction and expansion chamber of the first operating cylinder 15 has the pressurized fluid (compressed air) applied thereto, so that the reciprocating piston limiting this first contraction and expansion chamber, together with the first piston rod 15.1 thereof, is displaced and moves out. As a consequence thereof, the roller throw-on and throw-off bearing 5 is rotated in the counterclockwise direction with respect to FIG. 1. Because of the eccentricity of the roller throw-on and throw-off bearing (the eccentric bushing) 5, this rotation results in a lifting of the applicator roller 4 from the form and/or blanket cylinder 3 and movement thereof into a roller position wherein a spaced distance between the circumferential surfaces of the form and/or blanket cylinder 3 and the applicator roller 4 is about 1 to 2 millimeters. In this roller position, the third gear wheel 48 of the form and/or blanket cylinder 3 and the fifth gear wheel 50 of the applicator roller 4 which, together with the applicator roller 4, is moved into the roller position and therefore slightly away from the third gear wheel 48, remain in mutual meshing engagement. During the rotation of the roller throw-on and throw-off bearing 5 required for throwing the applicator roller 4 off, the first joint or link pin 14 slides along the slot 13 from a first into a second pin position relative to the first slot 13. In neither of the two pin positions does the first joint or link pin 14 bear on either of the two semicircularly rounded end surfaces defining the slot 13.

Due to the rotation of the roller throw-on and throw-off bearing 5 for the purpose of throwing the applicator roller 4 off, the second joint or link pin 45 is also lifted off the arcuately rounded end surface (end stop surface) defining the guide slot 44, and shown at the bottom thereof in FIG. 2. In a second print throw-off step, following the first step, the form and/or blanket cylinder 3 is thrown off the impression cylinder 2. For this purpose, simultaneously or shortly after one another, both contraction and expansion chambers of the second operating cylinder 19 are filled with the pressurized fluid (compressed air), so that the first piston rod 19.1 and the second piston rod 19.2 of the second operating piston 19 move outwardly. Consequently, the first lever 16, for one, is pivoted or swiveled in clockwise direction as viewed in FIG. 1 and, for another, the cam ring 7 is pivoted or swiveled in the opposite direction, i.e., in counterclockwise direction as viewed in FIG. 1, because of the “crossover attachment or linkage” of the second coupler 20 to the cam ring 7 and to the first lever 16. Because of the pivoting or swiveling of the cam ring 7, a region of the contour of the cam ring 7, which protrudes to a lesser extent than a widely protruding contour region 7.1, comes into contact with the sprung supporting roller 10, and a contour region that is less flattened than a greatly flattened contour region 7.2 comes into contact with the supporting roller 8, so that the cam ring 7, together with the form and/or blanket cylinder 3, is moved away from the impression cylinder 2. In this regard, the form and/or blanket cylinder 3 is moved a distance (actuating travel) amounting to less than 3 millimeters, for example, 1.2 millimeters, away from the impression cylinder 2, at least approximately along an imaginary center-connecting center line which connects a point of rotation or center point 51 of the impression cylinder 2 and of the fourth gear wheel 49 to a point of rotation or center point 52 of the form and/or blanket cylinder 3 and of the cam ring 7 and of the third gear wheel 48 to one another, i.e., is raised approximately or even exactly in the radial direction of the impression cylinder 2 and of the fourth gear wheel 49. The aforementioned extent is so low or the actuating travel is so short that the teeth of the third gear wheel 48 remain yet in mutual meshing engagement with the teeth of the fourth gear wheel 49 even after the printing has been discontinued or thrown off. Neither the mutual engagement or meshing of the teeth of the gear wheels 48 and 49 nor the existing mutual engagement or meshing of the teeth of the gear wheels 48 and 50 is lost due to the discontinuance or throw-off of the printing.

The parts identified by the reference numerals 6, 16, 17 and 20 are assigned to the plate and/or blanket cylinder 3 in duplicate and thus on both sides, i.e., not just on the machine side that is visible in FIG. 1, here namely the so-called drive side, but likewise on the machine side facing away in FIG. 1, here namely the so-called operating side. The second operating cylinder 19 actuates both cylinder throw-on and throw-off bearings of the form and/or blanket cylinder 3, namely the bearing on the drive side and the bearing on the operating side, simultaneously when the printing is thrown off and also when the printing is thrown on, which is explained further hereinafter, the coupler or four-bar mechanism on the operating side and the cylinder throw-on and throw-off bearing on the operating side (neither of which is visible in FIGS. 1 and 2) likewise being driven by the second operating cylinder 19 through the synchronizing shaft 18. It is believed to be readily apparent that the lever corresponding to the first lever 16 and disposed on the operating side requires only a single lever arm (for the attachment of the coupler on the operating side).

When the form and/or blanket cylinder 3 is thrown off, the second coupler 20 and therefore the slot 13 is displaced relative to the first joint pin 14 engaging in the latter. However, the slot 13 is of such dimensions that the first joint pin 14 neither comes out of contact nor into contact with either of the two end, rounded inner surfaces defining the slot 13 and, in particular, not with the rounded end surface closer to the cylinder throw-on and throw-off bearing 6 and at the bottom of the slot 13 as viewed in FIG. 1 due to the aforementioned displacement of the slot 13.

The throw-on of the printing of the form and/or blanket cylinder 3, to be performed after the stoppage, is carried out in three successive steps, which are explained hereinbelow in detail.

In the first printing throw-on step, the form and/or blanket cylinder 3 is moved from the cylinder position thereof, which is reached due to the printing throw-off, into an intermediate position, which is located between the cylinder positions assumed by the form and/or blanket cylinder 3 in “printing off” and “printing on”. In the first step, the form and/or blanket cylinder 3 is therefore not moved back immediately the entire actuating travel of, for example, 1.2 millimeters which the form and/or blanket cylinder 3 has traced during the printing throw-off, but initially only part of this actuating travel, for example, 0.5 millimeters, so that in the intermediate position there remains a distance of 0.7 millimeters between the cylinders 2 and 3 in the example. In order to carry out the first step, the application of pressurized fluid to the first contraction and expansion chamber of the second operating cylinder 19 is discontinued, so that the first piston rod 19.1 moves in again. In this regard, the applications of pressurized fluid to the third operating cylinder 23 and to the second contraction and expansion chamber of the first operating cylinder 19 continue to be maintained. Due to the inward movement of the first piston rod 19.1, the cylinder throw-on and throw-off bearing 6 is rotated back slightly through the first lever 16, which in this case pivots or swivels in counterclockwise direction, as viewed in FIG. 1, and furthermore through the second coupler 20, due to which the form and/or blanket cylinder 3 is moved towards the impression cylinder 2, and the teeth of the gear wheels 48 and 49 of the two cylinders 2 and 3, respectively, come into deeper meshing engagement with one another.

In the second printing throw-on step, the applicator roller 4 is thrown onto the form and/or blanket cylinder 3 again. For this purpose, the filling and admission, respectively, to the first contraction and expansion chamber of the first operating cylinder 15 with the pressurized fluid is discontinued again, so that the first piston rod 15.1 moves in and the roller throw-on and throw-off bearing 5 rotates back until the applicator roller 4 again bears on the form and/or blanket cylinder 3, and the second joint pin 45 strikes the arcuately rounded inner surface (end stop face) defining and located at the bottom of the guide slot 44, as viewed in FIG. 2. Due to the contact of the second joint pin 45 with the aforementioned inner face defining the guide slot 44, the magnitude of the pressure of the applicator roller 4 on the form and/or blanket cylinder 3 is defined exactly. The mechanism illustrated in FIG. 2 is so formed that, when the form and/or blanket cylinder 3 is in the intermediate position, the pressure of the applicator roller 4 on the form and/or blanket cylinder 3 is greater to an acceptable extent than when the form and/or blanket cylinder 3 is in the “printing on” position.

In the third printing throw-on step, the form and/or blanket cylinder 3 is set from the temporarily assumed intermediate position into the “printing on” position thereof again, i.e., in contact with the impression cylinder 2 and the printing material carried on the latter, respectively. In order to achieve this, the second piston rod 19.2 is then also moved in, by again discontinuing the application of pressurized fluid to the second contraction and expansion chamber of the second operating cylinder 19. Thereby, the first lever 16, the second coupler 20 and the cylinder throw-on and throw-off bearing 6 are moved back again into the initial position thereof shown in FIG. 1, and the form and/or blanket cylinder 3 covers the residual travel distance, which amounts to 0.7 millimeters in the example at hand, from the intermediate position to the “printing on” position. During the displacement of the form and/or blanket cylinder 3 from the intermediate position thereof into the “printing on” position, the applicator roller 4 maintains the position thereof, and the circumferential surface pressure between the form and/or blanket cylinder 3 and the applicator roller 4 decreases only slightly. In exactly the same way as the piston rod of the third operating cylinder 23, the second piston rod 19.2 of the second operating cylinder 19 remains in the retracted rod position thereof both during the printing throw-on and also during the printing throw-off described hereinbefore.

Both during the printing throw-off and during the printing throw-on, the first joint pin 14 performs a so-called empty stroke in the slot 13. In other words, during printing throw-off, the first joint pin 14 moves in one direction and, during printing throw-on, moves in the other direction along the slot 13 relative to the second coupler 20 without exerting a driving action on the latter. Likewise, during the printing throw-off and the printing throw-on, the second coupler 20 exerts just as little driving action on the first joint pin 14 and therefore the roller throw-on and throw-off bearing 5.

The reason therefore is that the length of the slot 13 is greater than the thrust travel covered by the first joint pin 14 within the slot 13, respectively, during the printing throw-off or throw-on. As viewed in the thrust direction of the first joint pin 14, during the printing throw-off and printing throw-on there is then always sufficient play (thrust play) present, by which the first joint pin 14 is reliably prevented from striking one and the other end inner face defining the slot 13.

In the second printing operating mode, the printing material is printed only with the multicolor imprint in the offset printing units and not varnished in the varnishing printing unit.

In the second printing operating mode, the printing material is therefore conveyed past the form and/or blanket cylinder 3 by the impression cylinder 2 without coming into contact with the form and/or blanket cylinder 3. In order to ensure this, the form and/or blanket cylinder 3 must be kept in a so-called inactive position when the second printing operating mode is being carried out, and therefore kept at a sufficiently large distance from the impression cylinder 2, which distance, at 20 millimeters, for example, is many times greater than the distance existing between the cylinders 2 and 3 in the “printing off” position of the form and/or blanket cylinder 3 and is 1.2 millimeters in the example at hand.

In the steps explained in detail hereinafter, the form and/or blanket cylinder 3 is moved from the “printing off” position thereof, the setting of which has already been described hereinbefore and the presence of which is assumed to be given in the following description, into the inactive position thereof:

Initially, the application or admission of pressurized fluid to the second contraction and expansion chamber of the first operating cylinder 15 is discontinued.

The subsequent application or admission of the pressurized fluid (compressed air) to the fourth operating cylinder 26, and the resultant displacement of the pawl 25 from the locking position thereof into an unlocking position is performed before the hereinafter explained changeover of the third operating cylinder 23.

Due to the pneumatic action of the fourth operating cylinder 26, the piston rod thereof is extended counter to the action of the restoring spring of the fourth operating cylinder 26 and, as a result, the pawl 25 is pivoted or swiveled in counterclockwise direction, as viewed in FIG. 3, so that the locking of the first lever 16 and the limiting of the pivoting or swiveling range of the first lever 16 by the catching hook of the pawl 25 is released. Pressurized fluid (compressed air) is then applied or admitted to the third operating cylinder 23 so that the piston rod of the latter exerts a stroke which is greater than that of the maximum possible strokes of the piston rods 19.1 and 19.2. Changing over the third operating cylinder 23 in this way causes the second lever 21 to be pivoted or swiveled in counterclockwise direction, as viewed in FIG. 1, around the second rotary joint 22, and the pivoting or swiveling movement of the second lever 21 to be transmitted to the first lever 16 by the second operating cylinder 19, in this case functioning as a rigid coupler, the second lever 16, because of the “crossover” attachment of the second operating cylinder 19, and the piston rods 19.1 and 19.2, thereof, respectively, being kept extended on the two levers 16 and 21, in this regard, being pivoted or swiveled in clockwise direction, as viewed in FIG. 1, about the first rotary joint 17. Together with the second operating cylinder 19, the two levers 16 and 21 form a fifth coupler or four-bar mechanism, the drive rocker of the fifth coupler being the second lever 21, and the driven rocker of the fifth coupler being the first lever 16. The pivoting or swiveling movement of the first lever 16, driven by the second operating cylinder 23, is transmitted through the second coupler 20 to the cylinder throw-on and throw-off bearing 6, the cam ring 7 of which is as a result rotated from the rotational position thereof corresponding to the “printing off” position of the form and/or blanket cylinder 3 into another rotational position, wherein the contour region 7.2 which projects particularly far radially and is remote from the center of the cam ring 7, respectively, is in contact with the sprung supporting roller 10, and the particularly far radially set back and close to center, respectively, contour region 7.2 is in contact with the supporting roller 8. The result of this rotational movement of the cylinder throw-on and throw-off bearing 6 is an increase in the distance existing between the cylinders 2 and 3 and to be measured along the cylinder-center connecting center line, of 1.2 millimeters in the example at hand, to a multiple thereof, to 20 millimeters in the example at hand. In other words, the result of the rotational movement of the cylinder throw-on and throw-off bearing 6 is the displacement of the form and/or blanket cylinder 3 from the “printing off” position into the inactive position and therefore yet farther away from the impression cylinder 2 than in the “printing off” position.

During the displacement of the form and/or blanket cylinder 3 performed along the center-connecting center line of the cylinders 2 and 3 and the gear wheels 48 and 49 coaxial therewith, into the inactive position thereof, the third gear wheel 48 firmly connected to the form and/or blanket cylinder 3 is also displaced into the inactive position and, in the process, is released from the mutual meshing engagement of the teeth thereof with the teeth of the fourth gear wheel 49 of the impression cylinder 2. In addition, during and at the same time, respectively, as the displacement of the form and/or blanket cylinder 3 into the inactive position thereof, the applicator roller 4 is entrained synchronously with the form and/or blanket cylinder 3.

The applicator roller 4 is automatically entrained and tracked, respectively, in this way in detail in the following manner:

The movement of the cylinder throw-on and throw-off bearing 6, already previously mentioned several times, for displacing the bearing 6 into the rotational position corresponding to the inactive position is transmitted by the first coupler 11 which, in the process, exerts a driving action on the first joint pin 14 through the stop face thereof, to the roller throw-on and throw-off bearing 5, which is consequently rotated thereby. In this regard, the roller throw-on and throw-off bearing 5 is rotated in counterclockwise direction, as viewed in FIG. 1, by bringing the end (lower) inner face defining the slot 13, facing towards the roller throw-on and throw-off bearing 5, into contact with the first joint pin 14. The inner face serves thereby as a stop face for the first joint pin 14. During this throw-on movement of the first coupler 11 relative to the first joint pin 14, the first coupler 11 overcomes dead thrust travel TS or lost motion of the first rotary and thrust joint 12 and, when there is contact between the first joint pin 14 and the stop face defining the slot 13, the driving action is then exerted by the first coupler 11 on the first joint pin 14 if the first coupler 11 is moved onwardly by the third operating cylinder 23 through the second coupler 20 and the cam ring 7. The two throw-on and throw-off bearings 5 and 6 are matched with one another with respect to the eccentricity and cam geometry thereof, so that the form and/or blanket cylinder 3 and the applicator roller 4 are displaced into the inactive position thereof away from the impression cylinder 2 without any significant change in the distance thereof from one another during the displacement of the form and/or blanket cylinder 3. In addition, during this synchronous displacement of the form and/or blanket cylinder 3 together with the applicator roller 4, the two gear wheels 48 and 50 are kept in tooth meshing engagement with one another.

After the second printing operating mode has been completed, in order to change back to the first printing operating mode again, the displacement of the form and/or blanket cylinder 3 from the inactive position thereof back into the “printing off” position thereof is required. In order that, during this displacement back, the first joint pin 14 be kept in permanent contact with the end inner face defining the slot 13, which faces towards the roller throw-on and throw-off bearing 5, the displacement back is performed with the second piston rod 15.2 kept extended by the application of pressurized fluid to the second expansion and contraction chamber.

Besides the switching or changeover operations mentioned hereinbefore, which serve for changing the printing operating modes and for switching the varnishing printing unit “printing on/off”, in the varnishing printing unit shown, various “feed adjustments” can also be set and adjusted. These are, firstly, the “printing feed adjustment” of the form and/or blanket cylinder 3 and, secondly, the “roller feed adjustment” of the applicator roller 4.

The printing feed adjustment influences the intensity of the pressure of the form and/or blanket cylinder 3 on the printing material resting on the impression cylinder 2. If a change is made from one printing material with a specific printing material thickness to processing a printing material with a different printing material thickness in the varnishing printing unit, then for the purpose of matching the printing material thickness of the varnishing printing unit, the printing feed adjustment thereof must be changed. When the form and/or blanket cylinder 3 is located in the “printing on” position, the printing feed adjustment can be described by the center spacing existing between the center (axis of rotation) 52 of the form and/or blanket cylinder 3 and the center (axis of rotation) 51 of the impression cylinder 2.

The roller feed adjustment influences the intensity of the pressure of the applicator roller 4 on the form and/or blanket cylinder 3 and on the resilient circumferential surface of the latter, respectively, which can be formed either by the flexographic printing form or the rubber blanket. When the form and/or blanket cylinder 3 is located in the “printing on” position, the roller feed adjustment can be characterized by the center spacing existing between the center 52 thereof and the center (axis of rotation) of the applicator roller 4 rolling on the form and/or blanket cylinder 3.

The printing feed adjustment is set by the first motor 30, which, in this regard, pivots or swivels the third lever 27 through the first threaded spindle 31, the resultant pivoting or swiveling movement of the third lever 27 being transmitted through the fourth coupler 46 to the eccentric pin 47. As a result of the rotational movement of the eccentric pin 47, which is imparted to the latter by the fourth coupler 46, in turn the supporting roller 8 is displaced slightly towards the impression cylinder 2 or a slight distance away from the latter, depending upon the selected direction of rotation of the first motor 30. The pivoting or swiveling movement of the third lever 27 is transmitted to the fourth lever 33 through the second threaded spindle 34, which does not itself rotate, in this regard, and through the fourth lever 33 to the shaft 29.

In FIGS. 1 to 3, the part of the entire mechanism located on the so-called operating side of the printing press is illustrated, and the part located on the so-called drive side is not visible.

The shaft 29 is firmly connected to a matching piece of the third lever 27, disposed on the drive side, for rotating therewith, so that the rotational movement of the shaft 29 is transmitted to the drive-side lever, therefrom to a drive-side coupler and from the latter to a drive-side eccentric pin with the supporting roller thereof. The drive-side coupler is the matching piece for the fourth coupler 46, and the drive-side eccentric pin is the matching piece for the eccentric pin 47. Thus, the two supporting rollers, i.e., the supporting roller 8 disposed on the operating side and the drive-side matching piece, without coming out of alignment with one another, are adjusted relative to the impression cylinder 2 and, as a result, the two cam rings, i.e., the operating-side cam ring 7 and the drive-side matching piece thereof, and the two axle journals of the form and/or blanket cylinder 3, mounted in the cam rings, are forced synchronously with one another towards the impression cylinder 2 by the two last-named supporting rollers or forced away from the impression cylinder 2 by the sprung operating-side supporting roller 10 and the drive-side matching piece thereof. During this printing feed adjustment change, the form and/or blanket cylinder 3 maintains the shaft-angle alignment thereof set relative to the impression cylinder 2, for example parallel to the latter.

In order for the center spacing (roller feed adjustment) set between the centers (axes of rotation) of the form and/or blanket cylinder 3 and the applicator roller 4 to be maintained in spite of the change in the printing feed adjustment, a tracking mechanism is provided, which tracks the applicator roller 4 automatically during each change to the printing feed adjustment in such a way that the applicator roller 4 follows the movement of the form and/or blanket cylinder 3.

The tracking mechanism functions as follows:

The pivoting movement of the third lever 27, serving for the printing feed adjustment and driven by the first motor 30, is transmitted through the third threaded spindle 35 to the fifth lever 36, so that the levers 27 and 36 are pivoted or swiveled together by the first motor 30. During the transmission of the aforementioned pivoting or swiveling movement from the third lever 27 to the fifth lever 36, the third threaded spindle 35 does not perform any screwing movement, and the third threaded spindle 35 functions as a connecting rod for maintaining the angular position of the levers 27 and 36 in relation to one another. The pivoting or swiveling movement of the fifth lever 36 is transmitted through the third coupler 41 to the roller throw-on and throw-off bearing 5 which, as a result, at the same time as the displacement of the cylinder throw-on and throw-off bearing 6 or of the supporting roller 8 thereof, is rotated in such a way that the center of the applicator roller 4 remains at a constant distance from the center of the form and/or blanket cylinder 3 during the displacement of the form and/or blanket cylinder 3. During the transmission of the pivoting or swiveling movement of the fifth lever 36 to the roller throw-on and throw-off bearing 5, the second joint pin 45 bears continuously on the arcuately rounded end face defining the guide slot 44, which faces towards the fifth rotary joint 42 and is at the bottom of the guide slot 44, as viewed in FIG. 2.

On the drive side, which is not illustrated in the drawing, the applicator roller 4 also has such a tracking mechanism assigned thereto, by which the roller throw-on and throw-off bearing of the applicator roller 4 on the drive side, likewise not illustrated in the drawing, is displaced in synchronism and with the roller throw-on and throw-off bearing 5 on the operating side for the purpose of applicator-roller tracking.

For various reasons, for example in order to be able to react to swelling of a rubber blanket of the applicator roller 4, correction and adjustment of the roller feed adjustment of the applicator roller 4 may be required, which is performed in the following manner:

By the intermediary of the third motor 37, the fifth lever 36 is pivoted or swiveled relative to the third lever 27 through the third threaded spindle 35, which in this case, as opposed to the function thereof in the aforedescribed applicator roller tracking, rotates about itself and thus executes a screwing movement. In this case, this pivoting or swiveling movement of the third lever 27 is transmitted to the roller throw-on and throw-off bearing 5 in exactly the same way as in the applicator-roller tracking described hereinbefore, i.e., through the third coupler 41.

As a rule, the adjustment of the roller feed adjustment by the mechanism provided for the purpose on the operating side is carried out synchronously with the mechanism provided for the purpose on the drive side, so that during this adjustment, the axial alignment of the applicator roller 4, as a rule parallel relative to the action of rotation of the form and/or blanket cylinder 3, is maintained, i.e., so that the pressure of the applicator roller 4 on the form and/or blanket cylinder 3 is changed to the same extent over the entire format width thereof.

In a departure from this regular case, however, it may sometimes be necessary to change the pressure of the applicator roller 4 on the form and/or blanket cylinder 3 in a manner which is different as viewed over the format width of the applicator roller 4, for example because the rubber cover of the applicator roller 4 has swollen to a greater extent at one end of the roller than at the other. If the angular alignment of the axis of rotation of the applicator roller 4 relative to the axis of rotation of the form and/or blanket cylinder 3 has to be changed and, for example, the roller feed adjustment has to be corrected only at the end of the roller on the operating side and not at the end of the applicator roller 4 on the drive side, then only the third motor 37 on the operating side and not the drive-side matching piece thereof is operated, so that the position of the operating-side, third four-bar mechanism, including the third coupler 41 thereof, is adjusted relative to the drive-side matching piece of the third four-bar mechanism and, therefore, the drive-side roller throw-on and throw-off bearing 5 is displaced relative to the drive-side roller throw-on and throw-off bearing, as a result of which the applicator roller 4 is moved, for example, from a parallel position into a skewed position relative to the form and/or blanket cylinder 3. Of course, the increase or reduction in the pressure of the applicator roller 4, introduced only at one end of the roller, can be introduced not just at the end of the roller on the operating side, as previously explained by way of example, but instead also only at the end of the roller on the drive side, depending upon the requirement.

In addition, for various reasons, the change to the printing feed adjustment of the form and/or blanket cylinder 3 may be required to a different extent on one machine side, for example the operating side, than on the other machine side, on the drive side in accordance with the last-mentioned example. In order to vary the printing feed adjustment set at one cylinder end, here the end on the operating side, between the cylinders 2 and 3, relative to the printing feed adjustment set at the opposite cylinder end, here the end on the drive side, between the cylinders 2 and 3, or to set a printing feed adjustment which is uniform over the entire cylinder length (format width), by the second motor 32, through the second threaded spindle 34, the fourth lever 33 together with the shaft 29 is pivoted or rotated in one or the other direction relative to the third lever 27, depending upon the direction of rotation of the second motor 32. The rotational movement of the shaft 29 relative to the third lever 27 on the operating side, in this case remaining in the position thereof, is transmitted to the matching piece thereof on the drive side. This lever, disposed on the drive side, is thus pivoted or swiveled by the second motor 32 and transmits the pivoting or swiveling movement thereof, through the coupler disposed on the drive side and representing the matching piece to the fourth coupler 46, to the eccentric pin likewise disposed on the drive side with the supporting roller thereof, which is the matching piece to the supporting roller 8. As a result thereof, the axis of rotation of this supporting roller disposed on the drive side is adjusted slightly and in parallel relative to the axis of rotation of the operating-side supporting roller 8.

1. A device for throwing-on impression and throwing-off impression in a printing press, comprising:
an impression cylinder;
at least one of a form and a blanket cylinder;
an applicator roller;
a roller throw-on and throw-off bearing for throwing said applicator roller on and off said at least one of said form and said blanket cylinder, said roller throw-on and throw-off bearing including a rotatably mounted first actuating element;
a cylinder throw-on and throw-off bearing for throwing said at least one of said form and said blanket cylinder on and off said impression cylinder, said cylinder throw-on and throw-off bearing including a rotatably mounted second actuating element;
a coupler forming a coupler mechanism together with said first and said second actuating elements; and
a thrust joint having a dead thrust travel and articulatingly connecting one of said actuating elements to said coupler.

2. The device according to claim 1, wherein said first actuating element is an eccentric bushing.

3. The device according to claim 1, wherein said second actuating element is a cam ring.

4. The device according to claim 1, wherein said thrust joint connects said first actuating element to said coupler.

5. The device according to claim 1, wherein said thrust joint is a rotary and thrust joint.

6. The device according to claim 5, wherein said rotary and thrust joint has a slot and a joint pin to be rotatably and displaceably guided in said slot.

7. The device according to claim 1, wherein said applicator roller is associated with said at least one of said form and blanket cylinder as a single applicator roller.

8. A printing press, comprising:
an impression cylinder;
at least one of a form and a blanket cylinder;
an applicator roller; and
a device for throwing-on impression and throwing-off impression, said device including:
a roller throw-on and throw-off bearing for throwing said applicator roller on and off said at least one of said form and said blanket cylinder, said roller throw-on and throw-off bearing including a rotatably mounted first actuating element;
a cylinder throw-on and throw-off bearing for throwing said at least one of said form and said blanket cylinder on and off said impression cylinder, said cylinder throw-on and throw-off bearing including a rotatably mounted second actuating element;
a coupler forming a coupler mechanism together with said first and said second actuating elements; and
a thrust joint having a dead thrust travel and articulatingly connecting one of said actuating elements to said coupler.
